(19) United States
(12) Patent Application Publication
(10) Pub. No.: US 2008/0028224 A1
(43) Pub. Date: Jan. 31, 2008

(54) Methods and Systems for Providing Integrity and Trust in Data Management and Data Distribution Processes

(76) Inventor: Errikos Pitsos, Munchen (DE)

Correspondence Address: SEED INTELLECTUAL PROPERTY LAW GROUP PLLC, 701 FIFTH AVE, SUITE 5400, SEATTLE, WA, 98104, US

(21) Appl. No.: 10/580,092

(22) PCT Filed: Nov. 21, 2003
(86) PCT No.: PCT/EP03/13109

§ 371 Date: Apr. 18, 2007

(51) Int. Cl. H04L 9/32

(52) U.S. Cl. 713/178; 713/176

(57) ABSTRACT

A method, a system, and computer-readable media having instruction for controlling client devices and server are provided for managing digital data According to one aspect, a method comprises associating digital data with predefined sets of digital data, computing a leaf hash values over some or all of the digital data and/or over identifications of some or all of the digital data that are associated with the predefined sets, and computing a root hash value, whereby the underlying hash algorithm has as an input at least said leaf hash values. The method further comprises determining the consistency of given digital data with said root hash value by identifying the set of digital data that is associated with given digital data, re-obtaining said root hash value, re-obtaining the hash values over which said root hash value was computed, computing a hash value over said re-obtained hash values, and comparing said re-obtained root hash values with said in the previous step computed hash value.

The present invention relates to data management ad distribution systems and particular embodiments relate to public key infrastructures within systems used to distribute digital data from one or more party via a public network to a plurality of other parties. In particular, processes for establishing data integrity and trust levels of digital data distributed over a public network such as the Internet is provided by the present invention.

In many applications it is desirable for a server to be able to prove to various clients the existence or non-existence of and additionally the integrity of some data or dataset.

Further, in systems such as a PGP (Pretty Good Privacy) system it is desirable that some “signing party” can digitally sign the public key of some other party of that system and thereby approving the identity of that “signed party”. It would in particular be desirable to provide a system that allows a third party that trusts or knows that “signing party” to also establish a trust “signed party's” identity or public key without having to know the “signed party's” identity. The known system have the disadvantages that most parties (clients) know only a small group of other parties and a signature on another public key is not an effective way to establish trust in that key, because the receiving party of that key has to know and trust the signer's identity which is not the case in most cases of receiving an previously unknown key.

Moreover, it desirable to provide a system and method establishing integrity information of locally used data in a distributed system such as the Internet. Often many users that use parts of globally used dataset, where globally means that many users in a system use that dataset. It is desirable to provide a method that can assure that this data is the same (and unaltered) for all users using that data. It is known that data is signed with some trusted key or by a trusted third party that is centralized and trusted by all users. This, however, establishes a trust that is based on that centralized, third party. This is clearly a disadvantage since all users have to trust this party, they depend on the integrity of that party and this system requires a centralized infrastructure supported by this third party.

It is the object of the present invention to provide systems and methods, as well as computer-readable media comprising instructions that accordingly control a plurality of user terminals and servers of such systems and methods, accomplishing and allowing for the aforementioned advantageous and desirable aspects and features. Further advantages and aspects of the present invention are apparent from the following description and claims.

This object is solved by the subject matters of the independent claims and preferred embodiments are defined by the subject matters of the dependent claims, which from a part of the disclosure regarding the present invention.

According to one aspect of the present invention, there is provides a method and system for managing digital data. Digital data is associated with a first predefined set of digital data, whereby at least two predefined sets of digital data exist and said first predefined set of digital data can be distinguished from the other predefined sets of said at least two predefined sets.

A first leaf hash value is computed over some or all of the digital data (and/or over identifications of some or all of the digital data) that are associated with said first predefined set. Also, at least a second leaf hash value over some or all of the digital data (and/or over identifications of some or all of the digital data) that are associated with a second predefined set of said at least two predefined sets is computed. If more than two predefined sets exist, for each remaining set of said at least two predefined sets is computing respectively a leaf hash value over some or all of the digital data and/or over identifications of some or all of the digital data associated with a remaining predefined set.

Further, a root hash value is computed, whereby the underlying hash algorithm has as an input at least said leaf hash values that are respectively computed for each of said at least two predefined sets of digital data. The computation of the root hash value comprises at least the computation of a first non-leaf hash value over at least said first and said second leaf hash value.

Further, the consistency of afterwards given digital data with said root hash value is determined by identifying the set of digital data that is associated with given digital data, re-obtaining said root hash value, re-obtaining the hash values over which said root hash value was computed, whereby at least the leaf hash value over some or all of the digital data (and/or over identifications of some or all of the digital data) associated with said identified set of digital data is re-computed applying the same computing scheme as employed for the computation of the first and the second leaf hash value.

Then, at least a hash value over said re-obtained hash values is computed applying the same computing scheme as utilized for computing a root hash value. The re-obtained root hash value is then compared with the respective afore-computed hash value and the consistency of the given digital data with the root hash value is determined based upon the comparison result, whereby consistency is determined if said comparing resulted in equal hash values.

According to another aspect of the present invention, there is provides a method and system for providing trust levels of signatures in a system comprising a plurality of parties connected via a public network, wherein the system provides a public key signature scheme for said pluralities of parties. The method comprises signing a public key PK1 of a first party by a second party using a private key SK2, signing digital data D by said first party using the private key SK1 corresponding to said signed public key PK1, obtaining said signed digital data D and said signed public key PK1 by a third party, whereby said first party is unknown and/or not trustworthy to said third party, determining said second party as a signing party of said signed public key PK1, determining whether said second party as a signing party is known and/or trusted by said third party. If said second party (as said signing party) is known and/or trusted by said third party the method further obtains the public key PK2 of said second party corresponding to said private key SK2, verifies said signed public key PK1 using said public key PK2 of said known and/or trusted signing party, and if the verification of said signed public key PK1 was successful, verifies the signed digital data D using said signed public key PK1.

According to yet another aspect of the present invention, there is provides a method and system for providing integrity and consistency information of digital data for at least two parties of a system comprising a plurality of parties connected via a public network. The method comprises creating a list of identifications of digital data by a first party of said system, computing a hash value over some or all of the identifications of said list and associating said hash value with said list.

Further, the list and said hash value is provided to a second party of said system and the one or more of identifications in corresponding list in possession of said second party are compared with the corresponding one or more of identifications in said obtained list. The consistency of both lists is then verified by computing a hash value over some or all of the identifications of said obtained list, computing or obtaining a hash value over some or all of the identifications of said corresponding list, and comparing both hash values. If said comparing step results in equal hash value, establishing that both list are consistent.

In the following the invention is described with reference to the figures illustrating:

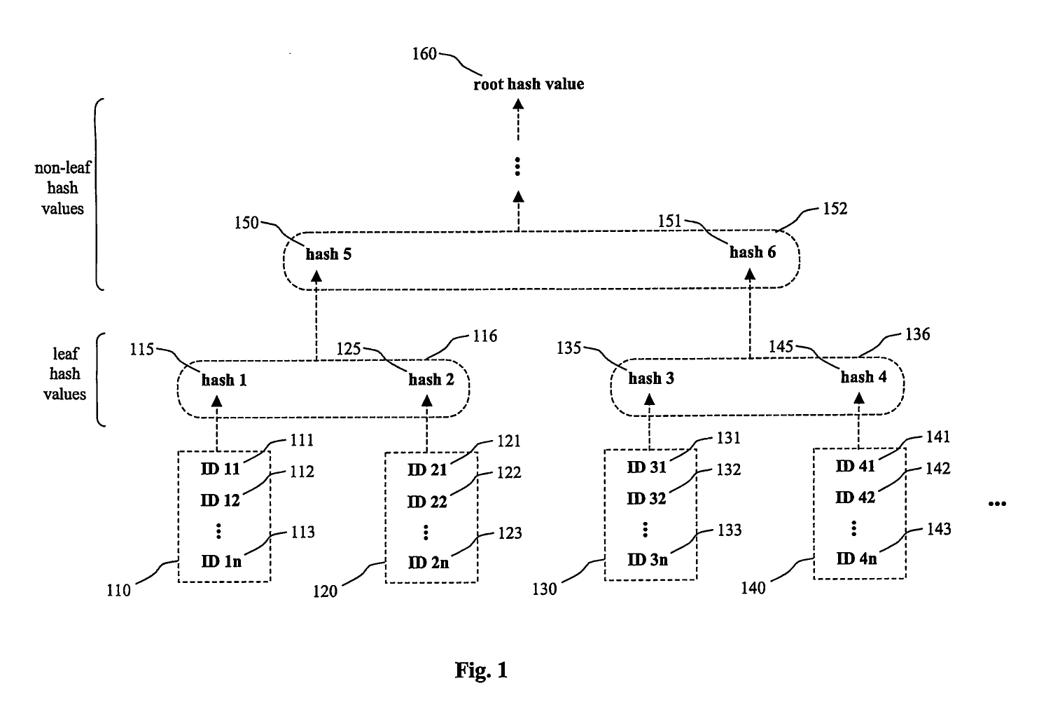

FIG. 1 a high level overview of a process providing for a tree structure of hash values according to an embodiment of the invention;

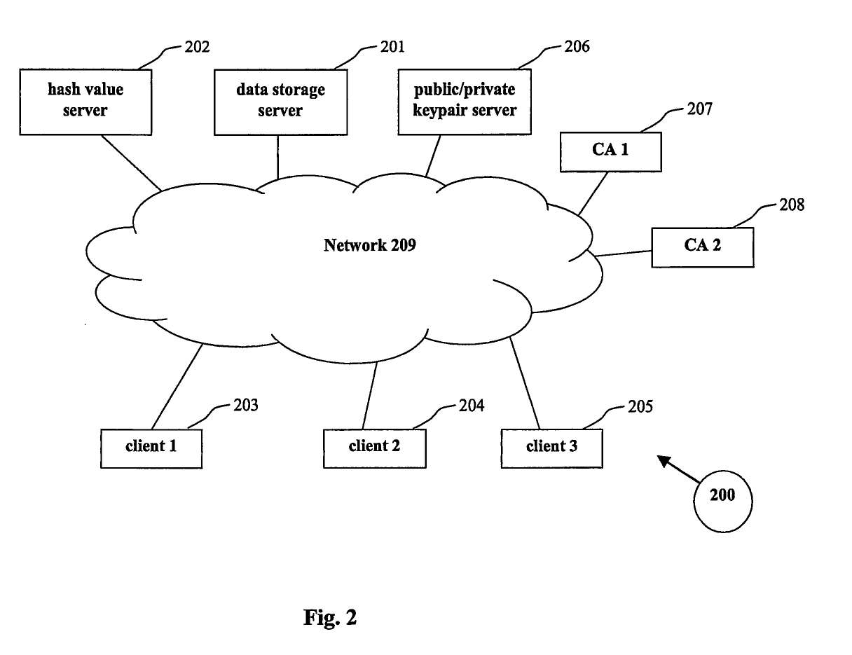

FIG. 2 an exemplary system providing a public key infrastructure;

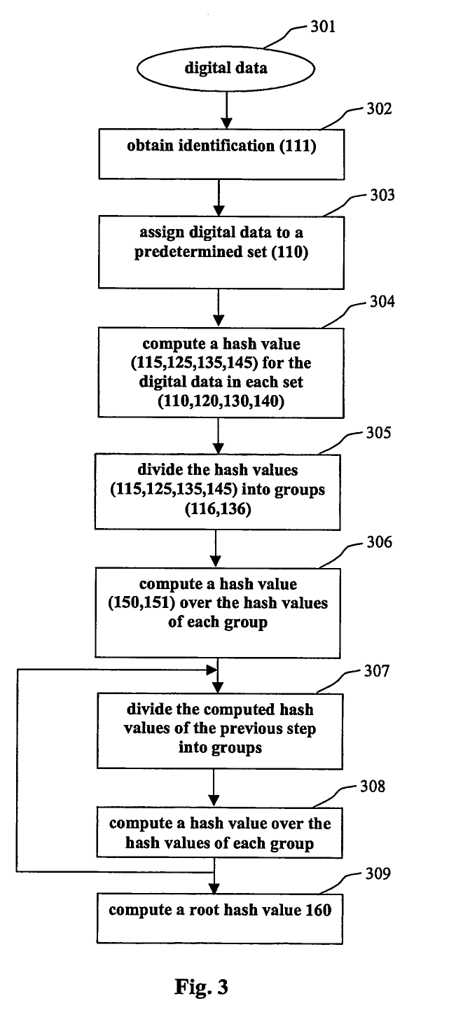

FIG. 3 a high level flowchart illustrating a computation of hash values according to an embodiment of the invention;

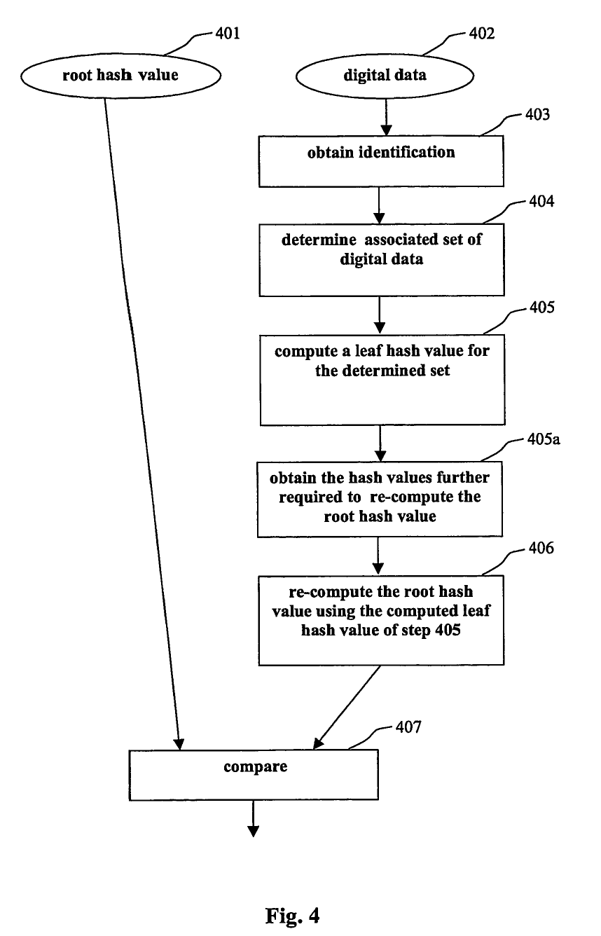

FIG. 4 a high level flowchart illustrating a verification process of digital data according to an embodiment of the invention;

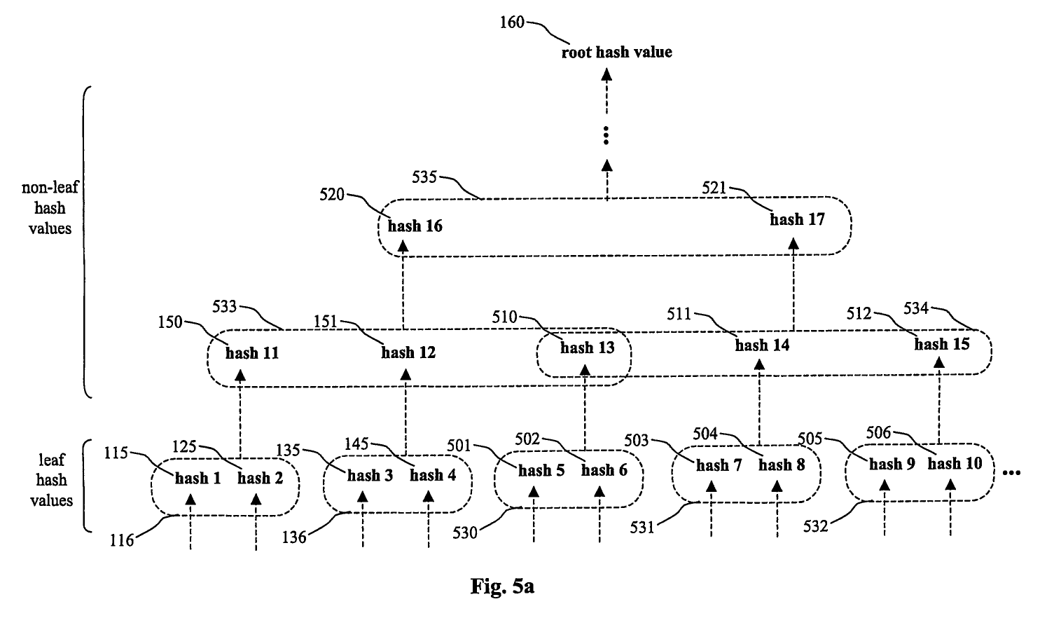

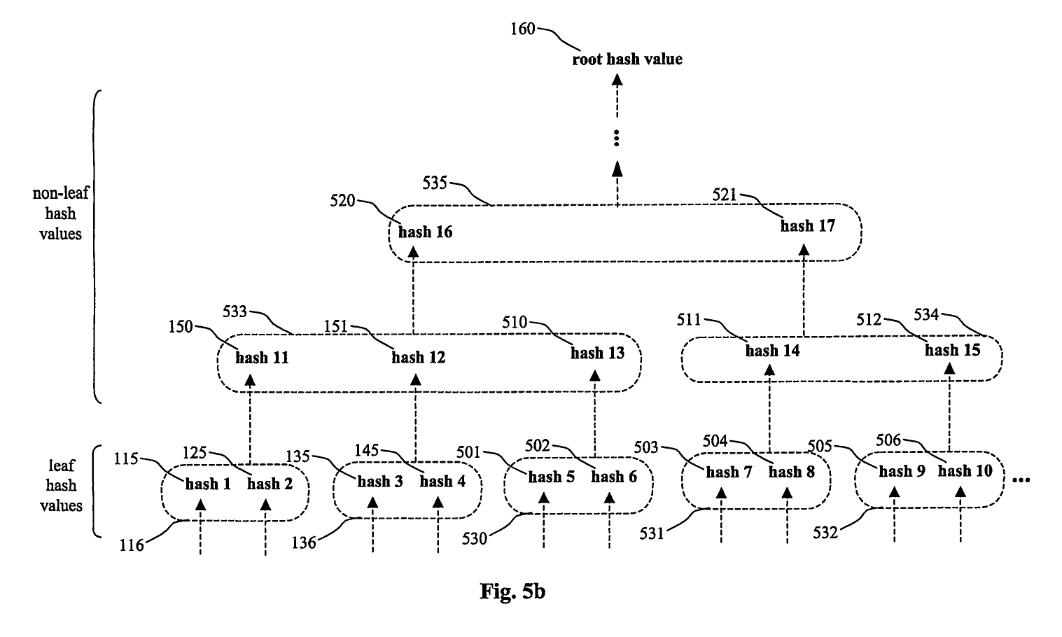

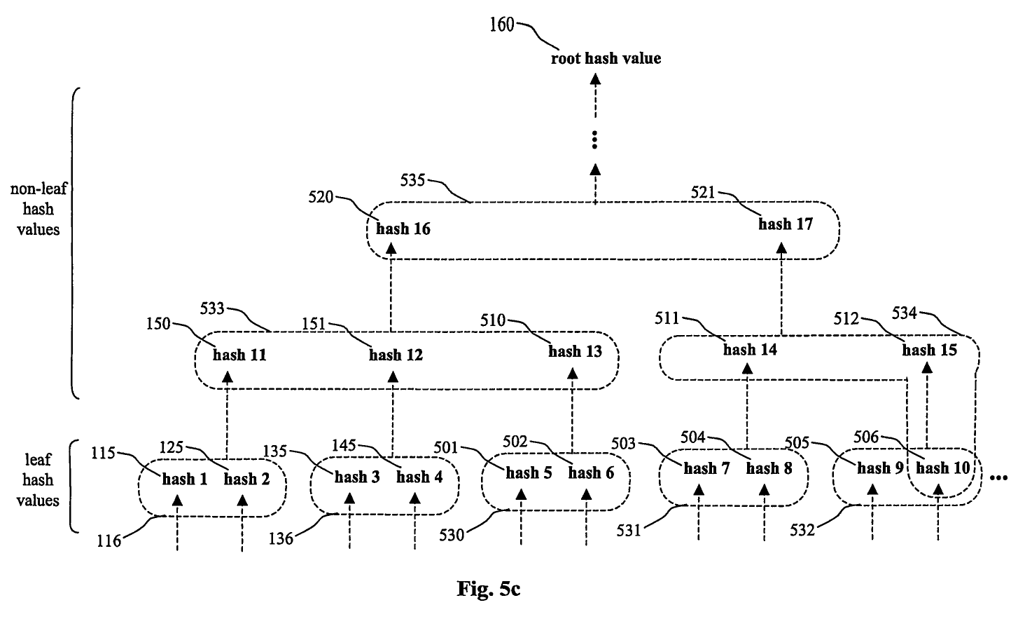

FIG. 5a a high level overview of a process providing for a tree structure of hash values according to a first embodiment of the invention;

FIG. 5b a high level overview of a process providing for a tree structure of hash values according to a second embodiment of the invention;

FIG. 5c a high level overview of a process providing for a tree structure of hash values according to a third embodiment of the invention;

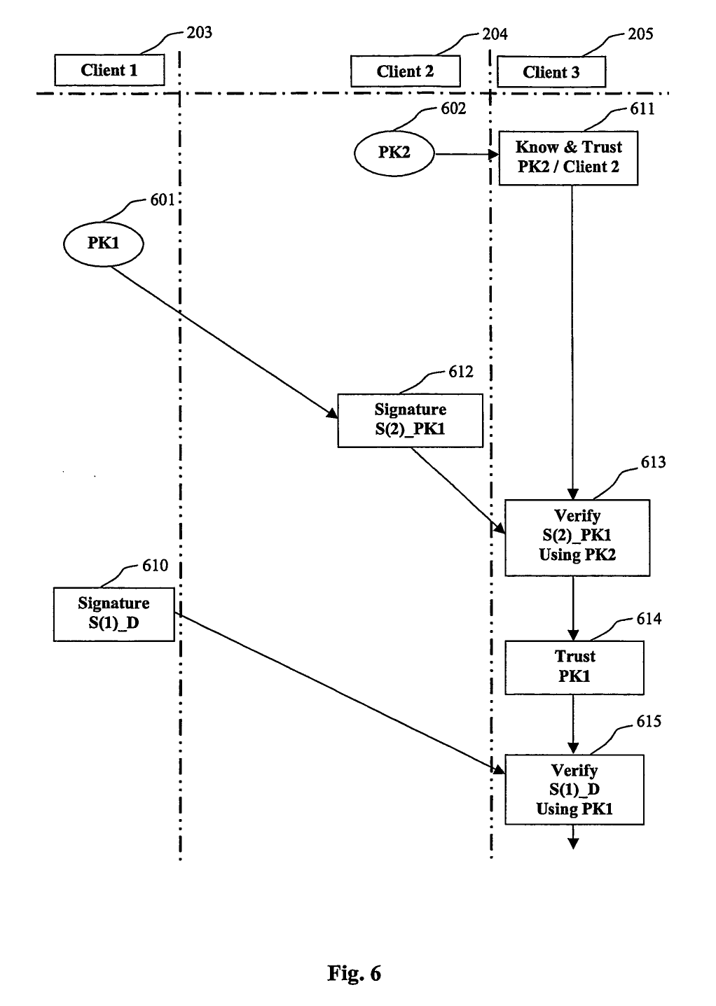

FIG. 6 a high level overview of a process providing for a trust establishing process for signatures and/or digital data in a public key infrastructure according to a first embodiment of the invention;

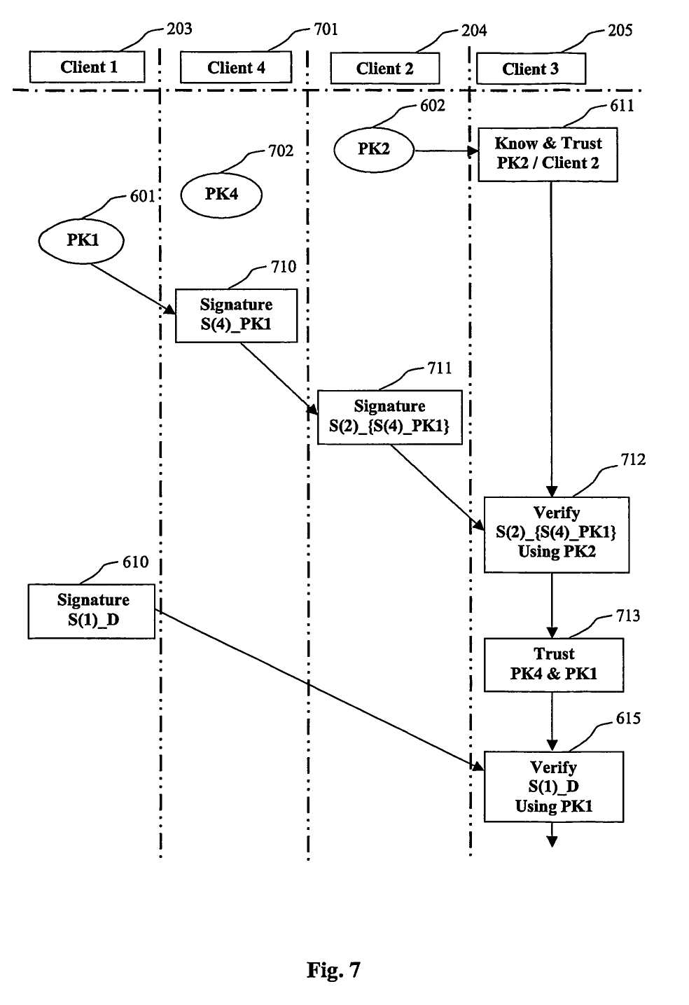

FIG. 7 a high level overview of a process providing for a trust establishing process for signatures and/or digital data in a public key infrastructure according to a second embodiment of the invention; and

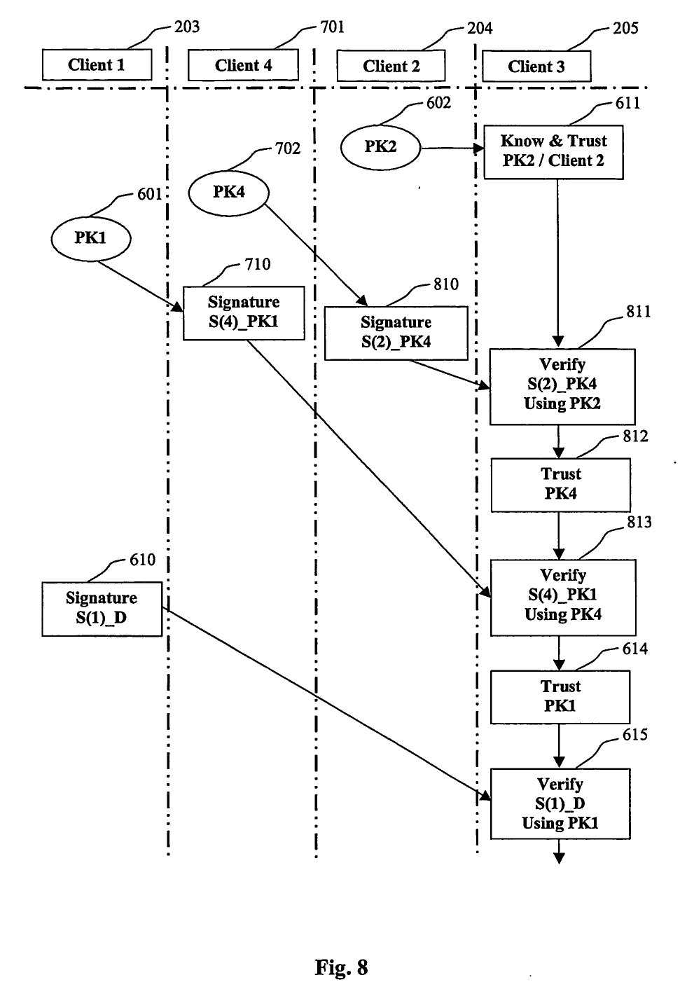

FIG. 8 a high level overview of a process providing for a trust establishing process for signatures and/or digital data in a public key infrastructure according to a third embodiment of the invention.

In the following, a first aspect of the invention is described regarding the management and distribution of digital data using hash values; The subsequently described embodiments providing a method and system for managing, storing and distributing digital data, whereby the integrity of the digital data can be verified.

In particular, a system wherein digital data is distributed or provided to several participating parties the following embodiments allow that each party can verify the integrity or consistency of digital data with some independently obtained information, which is in principle a single hash value as will be defined in the specific embodiments. In addition, the method and system allows that several parties of this system can also prove the existence or non-existence of digital data within this system. In particular, the described methods may be performed within a server-client system, wherein a server can prove to several clients the existence and additionally the integrity of digital data, whereby the clients can verify the correct operation or integrity of the server and that the same information is given to all clients.

Throughout this application the term “digital data” is used to denote any sort of data that can be digitally stored or distributed, such as program files, data files, configuration files, software code, new versions or updates of any of the aforementioned data files, e-mail messages, digital certificates, public keys, or combinations thereof.

The invention is described by the following specific embodiments illustrating some exemplary scenarios that are considered providing a person skilled in the art sufficient knowledge to understand the present invention. Accordingly, these embodiments are meant to be exemplary rather than exhaustive. Those features of common knowledge to the skilled person are not described in detail herein.

FIG. 1 shows an exemplary chart illustrating a first aspect of the present invention. According to this aspect, the existence and the integrity of digital data can be determined by using a classification and verification procedure that is based on hash functions. According to a preferred embodiment of the present invention, each digital data, for instance a data file or a public key, is associated with one of a plurality of different sets of digital data (110, 120, 130, 140). In other words, each digital data that is managed or distributed using this procedure is assigned to one set of digital data. This assignment or association may involve physically storage the digital data entries in respective storage locations or on respective storage media representing these different sets of data. Alternatively, assigning or defining a respective identifier for the digital data may accomplish the assignment or association. Similarly, immanent and already existing information or identifiers allowing distinguishing different sets of data may be used to accomplish the plurality of sets (110, 120, 130, 140). Several other identifications are conceivable that are known to the skilled person and are not further discussed herein. However, one particularly advantageous embodiment may use the binary representation of the digital data itself, of an identification of that digital data, or of a hash value of one or both of the aforementioned to obtain an association with one predefined set. As an example, a predefined bit-string such as the n least significant bits within an identifier for each data can provide the association with a specific set. The identifier for each data may be a file name, an email address, file attributes or a unique identification number of said data and the number represented by the bit-string may correspond to a set of digital data.

According to one specific embodiment, an identification for each digital data exists that unambiguously assigns a predefined set to each digital data. According to another specific embodiment, a digital data may be part more then one predefined set. According to yet another specific embodiment, this identification can be assigned to each digital data when being entered into this system.

The total number of predefined sets and/or the total number of data entries in each set can be predetermined and fixed in a manner so as to result in a statistically even distribution of digital data for each set.

In the following, the main aspects of the present invention are described using as an example a client-server system 200 as illustrated in FIG. 2.

FIG. 2 shows a system 200 comprising a plurality of clients 203-205 that are connected via said network 209, for instance the Internet, to at least one server. As an example, FIG. 2 shows a hash value server 202 and a data storage server 201. The data storage server illustrates a server means that stores the digital data to be distributed to the plurality of clients and the hash value server 202 illustrates a server means that is used to compute, maintain and distribute the hash values as subsequently described. Both server means may, however, also be comprised in a single server entity or even further distributed among three or more server entities. This exemplary client-server system 200 represents a public key network providing for a public key signature scheme available for the client and/or the server. Therefore, a private/public key server 206 is illustrated that may issue, distribute or maintain the public keys within the system. As an example, two certificate authorities 208, 209 are also illustrated to create and issue certificates of the public keys for each client as commonly used within public key networks.

Even though the remaining embodiments are described in view of this exemplary network 200, it should be noted that the embodiments, if not explicitly stated otherwise, is not limited to such client-server systems. Instead, the invention in general relates to the management and verification of the existence and integrity of digital data.

According to one embodiment, the digital data associated with each predefined set (110, 120, 130, 140) is used to compute a single hash value (115, 125, 135, 145). According to another embodiment, an identification (111-113, 121-123, 131-133, 141-143) of each digital data entry in each set is used to compute a single hash value for each set 110, 120, 130, 140. As indicated above, this identification may be a hash value itself that was computed for each data entry. In either case, one hash value may be computed over the digital data entries or its identifications associated with each predefined set. These hash values are hereinafter denoted as leaf hash values 115, 125, 135, 145.

These leaf hash values can then be used to compute in one or more steps a single hash value, which will be denoted hereinafter as a root hash value 160. This root hash value may be used to verify the integrity of the whole hash data and thereby to verify the integrity of that digital datasets in the system and/or the existence or non-existence of the digital data as described subsequently in more detail.

To verify the existence or non-existence of digital data, one may first determined the predefined set 110 that would be associated with the digital data. For this, either the identification 111 is obtained or assigned as mentioned above and the respective set of digital data is requested by a client.

In the following description, the system 200 is used to distribute public keys of clients within the system 200 and a client 203 receives the public key of another client 204 and desires to determine the integrity of that received public key. In other words, the digital data to be distributed and verified in terms of data integrity is a public key. This example is employed only to describe the embodiment in an illustrative manner and it should be appreciated that the invention in general relates to any kind of digital data as indicated above.

The client 203 may first determined the predefined set 110 that this public key would be associated with. The client may then request the data entries or the identifications of theses data entries 111-113 comprised in this identified, predefined set 110 from a server (201, 202), and subsequently compute the leaf hash value 115 of this set 110 in the known and predetermined manner as described above.

According to one simple embodiment, the client 203 may check whether or not the public key is part of the digital data entries or its identifications associated with this identified set of digital data 110. This embodiment, however, provides only a limited certainty for the integrity of the public key in question since the client can only establish the consistency of this public key with the requested data of that predefined set. There is no obvious and easy way to verify the integrity of that requested (and eventually received) digital data or identifications thereof. Therefore, the following embodiments provide for a verification of the integrity of this requested predefined set and thus for the integrity of the public key that has to be verified as part of this set.

Therefore, the root hash value 160 is distributed among the clients 203-205 in the system 200. Returning to the previous example, the client has identified the associated predefined set 110 of the public key (111) to be verified, requested and obtained the remaining digital data (112, 113) associated with this identified set, and has computed the leaf hash value 115 for this set 110. The client now re-computes the root hash value 160 using this computed leaf hash value 115.

Because the root hash value is securely distributed as described subsequently and/or all clients may compare this root hash value between each other without a server intervention or a further third party involvement, and because the underlying hash algorithms are cryptographically secure, the client can establish the consistency of this securely distributed root hash value 160 with the leaf hash value 115 of the predefined set 110 comprising the public key in question (111).

It is known that a hash algorithm provides a cryptographically secure one-way function that can be used to verify the integrity of the input to this hash algorithm. To verify a set of digital data, for instance a public key, a hash value over all possibly digital data entries to be verified has to be computed. This, however, would require that all the digital data entries have to be obtained when a specific digital data entry has to be verified. This would not be applicable for large sets of digital data. The present invention, therefore, provides in further embodiments a method that on one hand provides a hash value, namely the root hash value 160, computed by a procedure based on hash algorithms having as an input all digital data entries, and on the other hand does not require all digital data entries for re-computing of this root hash value 160 when verifying the integrity of a specific data entry (111).

The computed leaf hash values for each predefined set of digital data 115, 125, 135, 145 are, therefore, divided into several groups (116, 136). Then, a further hash value 150 is computed over the leaf hash values 115, 125 of each group 116. These computed hash values are denoted hereinafter as non-leaf hash values 150, 151.

These non-leaf hash values may then be further divided into groups (152) of hash values and respectively a further non-leaf hash value is computed of the hash values of each group (150, 151). This may be repeated until a single hash value is computed, namely the root hash value 160. The hash value server 202 may perform this procedure.

The root hash value 160 is then securely distributed to each client. This may be accomplished by sending this root hash value, preferably encrypted, to each client by the server. According to another embodiment, the root hash value may also be distributed by a client to another client, whereby the root hash value is preferably also encrypted and/or signed by the sending client. In addition, some sort of trust level, as explained later in a further aspect of the present invention, may be attached to the distributed root hash values. A client receiving a root hash value from one or more clients may, therefore, only accept this root hash value if it can establish its integrity or if it has a specifically required trust level.

When a client wishes to verify a specific digital data, for instance a public key as in the example above, the client computes the leaf hash value 115 of the set of digital data associated with this public key (111) to be verified. In order to re-compute the root hash value 160, the client requires the non-leaf hash values (150, 151) and the leaf hash values (125, 135, 145) of the remaining sets of digital data (120, 130, 140). The client may, therefore, request the remaining leaf hash values from the server 202. The client may then re-compute the root hash values based on the obtained leaf hash values and the computed leaf hash value for the identified set comprising the public key in question. If the computed root hash value is equal to the securely distributed root hash value, the consistency of the public key with the securely distributed root hash value is established and thus the integrity is established. In addition, since the association of digital data, for instance a public key, with a predefined set is known, any client can request the respective set and verify whether or not this public key exists. Because the root hash value is known to all clients and securely distributed, it is not possible for an adversary or even for for that hash server itself to manipulate or forge the digital data of a predefined set or the requested hash values.

In a further embodiment, only these non-leaf root hash value (150) are computed that require as an input the leaf hash value 115 of the identified set of digital data 110 comprising the public key 111. This embodiment becomes apparent from FIG. 5A. FIG. 5A illustrates an exemplary tree structure for the computed hash values. For this, the leaf hash values 115, 125, 135, 145, 501-506 are associated with a first layer of this tree structure. In this specific embodiment illustrated in FIG. 5A, these leaf hash values are divided into groups of two hash values each (116, 136, 530-532). For each group, a non-leaf hash value 150, 151, 510-512 is respectively computed that are associated with a second layer of this tree structure. Likewise, the non-leaf hash values 520, 521 are computed and associated with a further layer of this tree structure and the root hash value 160 forms the top layer of this tree structure. Assuming the public key in the described example was identified as part of the group belonging to the leaf hash value 115, then according to the second embodiment only the non-leaf hash values 150 and 120 as well as the root hash value 160 are computed by the client. Accordingly, only the leaf hash value 125 and the non-leaf values 151, 510, and 521 have to be obtained by the client in order to compute the root hash value 160, whereas the remaining leaf and non-leaf hash values are not necessarily required.

According to one embodiment of the invention, the total number of the predefined sets is a power of 2. The sets could then be numbered and a predefined bit stream obtained from digital data or from an identification of digital data could serve as the association or assignment of that digital data to one of these predefined and numbered sets of digital data. The leaf hash values could then be divided into mutually exclusive groups of two hash values. For each group a non-leaf hash value can then be computed and in any of the further layers of the tree structure the non-leaf hash values can again be divided into groups of two hash values until the root hash value has been computed. Alternatively, the total number of sets may not be a power of 2 but a power of another integer.

According to another embodiment, the total number of predefined sets and/or the total number of hash values used to compute a non-leaf hash value of a next layer in the tree structure may be chosen independently from one another and may not be the same for each layer. This case is illustrated by FIG. 5A wherein groups of two leaf hash values are used to compute the non-leaf hash values of the first layer and respectively three non-leaf hash values of the first layer are used to compute a non-leaf hash value of the second layer in this tree structure. FIG. 5B illustrates an example of a further embodiment of the invention, wherein in the first layer of this tree structure respectively three hash values 150, 151, 510 are covered by the non-leaf hash value 520, whereas for the non-leaf hash value 521 only two non-leaf hash values 511, 512 are used. Such a scenario may be used when the total number of hash values is not an integer multiple of the number of hash values that have to be used to compute the non-leaf hash value of the next above layer. The same can be applied regarding the number of predefined sets. Another embodiment in this regard is shown by FIG. 5C, whereas in the second layer it is assumed that three hash values have to be used to compute a hash value of the third layer. FIG. 5C shows as an example five non-leaf hash values of the second layer 150, 151, 510-512 similar to FIG. 5B. The method of computing the non-leaf hash values may therefore define that for the last non-leaf hash value 521 the remaining two non-leaf hash values 511, 512 of the next lower layer have to be used and in addition a defined and/or specified hash value of the second lower layer is used, for instance leaf hash value 506. The person skilled in the art will however appreciate that the embodiments described in FIGS. 5A-5C may be combined and extended in a similar manner as described above. For instance, overlapping the groups in each layer by at least one hash value as shown by FIG. 5A (hash 13) can be applied as a standard procedure to some or all layers of the tree structure in order to provide a higher level of trust and verification.

FIGS. 3 and 4 respectively show an overview of the method steps in accordance with the above described embodiments of the present invention. These illustrative flowcharts however provide only an exemplary overview and a general understanding of the respective embodiments of the invention, which is not limited to those method steps and may also deviate from these procedures.

FIG. 3 refers to a one embodiment of the invention, wherein an identification of digital data is obtained in step 302 and the digital data 301 is assigned to one of the predefined sets in step 303. In another embodiment, however, digital data may be assigned to more than one predefined set. A leaf hash value is computed for each predefined set. In steps 305 and 306, the non-leaf hash values are computed as described above. Steps 307 and 308 refer to the different layers of the tree structure and the computation of the non-leaf hash values and respectively the computation of the root hash value as indicated in step 309.

FIG. 4 illustrates one example of verifying the integrity and/or the existence of digital data as it may be performed by a client in system 200. It is assumed that a client intends to verify the existence and/or integrity of the digital data 402, which may be a public key of another client. The client may therefore obtain the verification of this digital data in step 403 in order to identify the predefined set that is associated with this digital data in step 404. Both steps 403 and 404 may also be comprised in a single step in case the digital data to be verified, for instance a public key or a public key certificate, already implicitly specifies the set of digital data as described above. In steps 405 and 406, the tree structure is recomputed as already described in connection with the previous figures. The finally computed root hash value is then compared to the received root hash value 401 in comparing step 407. If both hash values match and the client trusts the integrity of the root hash value as received, the client has verified that the digital data exists and could establish the integrity. If the root hash value as received by the client is distributed in a secure manner, the integrity and/or existence of the digital data can be verified without requiring a trusted third party.

It is therefore possible to provide an application that allows a server proving to several clients the existence or non-existence and in addition the integrity of some data. It can therefore be assured that all clients have the same information about the existence and the content of some data, even if the total number of data sets is too big to transfer to each client. The server can distribute the root hash value to each client and the clients may further exchange the root hash value among one another, for instance by attaching it to messages which can even be performed on a regular basis. Because the server in the latter case would have no influence on the distribution of the root hash value, the clients will have to determine whether they have the latest version of the root hash value to be applied to the digital data in question. This may be accomplished by using a timestamp attached to a hash value, the digital data and/or the hash values as requested by a client from the server during this verification procedure. The associated timestamp information is however only one example and many other identifications could be used instead, as known by the art. The tree structure as for instance the number of predefined sets, the number of digital data or identification entries in each set, and/or the total number of hash values in each group at the different tree structure layers may also vary, may be adjustable, or may be specified by, for instance a server, in order to effectively control the computational payload and/or the data to be distributed via the network. Also, some client or some application running on a client terminal and performing the procedure of verifying digital data may specify the number of verifications that have to be performed according to a required level of trust. This may involve verifying more than one set of digital data of a tree structure or re-computing more than that non-leaf hash values that are necessary to re-compute the root hash value of said tree structure, when digital data has to be verified by a user.

Further aspects and embodiments of the present invention refer to creating trust levels of public keys and/or digital data that was signed by a public key in a public key system, as for instance system 200. In public key systems, for instance in a PGP (Pretty Good Privacy) system, often public keys are signed by another party of this system, for instance another client. By this, the recipient of that signed public key can approve of the identity of the public key holder. This however requires that the recipient of a signed public key knows and/or trusts the signing party of that received public key. Because a client usually knows and trusts only a limited number of other parties in a system, such a system provides only a limited applicability, because if a received public key is signed by a third party which is unknown or not trusted by the recipient of the signed key, the recipient cannot establish whether or not to trust the identity of the key holder or the key itself. A trust is therefore built on the statement of signing party about the party for which the signature is issued as described in more detail subsequently.

Therefore, such a public key system may be extended in a manner that can create trust on a signed public key without actually knowing the signing party of that key. The same however applies to digital data that was signed with the private key of a key holder, because in order to verify the signature of that signed digital data, the verifying party has to trust the respective public key of that key holder required for this signature verification. Therefore, in the following the description mainly refers to signatures on public keys, but the invention in general applies to any kind of digital data.

According to one embodiment of the present invention, some signing party in a system signs a key and thereby assigns a certain amount of trust to that signed public key for a third recipient of that signed key without requiring that the third recipient knows the signing party or its public key.

FIG. 6 illustrates one example explaining an embodiment of the present invention regarding these aspects of establishing trust levels of public keys without explicitly requiring a trusted third party infrastructure that certifying the public keys as for instance a certificate authority does. The example given in FIG. 6 assumes that a first client 203 issues a signature on some digital data D (610) using its private key in a public key signature scheme. In order to verify this signature 610, one requires the corresponding public key 601 of that first client corresponding to the private key used to issue the signature 610. It is further assumed that this digital data D, for instance another public key, is provided to another client 205, for instance via the public network 209. The client 205 then determines that the signature on that data D was issued by that first client and can obtain the respective public key 601, for instance from a public key server or another client within the system 200. It is assumed that the client 205 does not know this public key 601 or the corresponding client 203. Consequently, client 205 requires some trust on that public key in order to establish whether or not the signature 610 can be trusted. The example given by FIG. 6 shows that a further client 204 has signed the public key 601 of that first client 203. This signature 612 on the public key 601 can be verified using the respective public key 602 of that client 204. Client 205 obtains the signature 612, identifies the signing party 204 and obtains the respective public key 602. The client 205 as shown in FIG. 6 is assumed to trust and/or know the public key 602 or respectively the client 204. Therefore, client 205 may verify the signature 612 using the trusted pubic key 602. According to another embodiment of the present invention, this signature 612 assigns a trust information to the signed public key 601 for client 205. Consequently, client 205 establishes this trust level, for instance by this verification process 613, and also trusts thereafter public key 601. Client 205 can then verify the signature 610 and if this verification was successful, it has established the integrity of the digital data D.

According to further embodiment, the trust information associated with the signature on another public key may be accomplished by attaching or associating an explicit trust information value and/or signing party trust identification value to the signature or the respective public key itself.

This simple example shown in FIG. 6 can also be extended to a chain or even a tree of assigned trust values to a specific signature. The main principle of this trust level chain or trust level tree is illustrated in FIG. 7. Similar to FIG. 6, FIG. 7 shows the clients 203, 204, 205, as well as the public keys 601, 602, as well as the steps of assigning the digital data 610 and verifying the digital data using the public key 601 in step 615. These steps are identical to the corresponding steps in FIG. 6. However, according to the example in FIG. 7, a fourth client 701 has issued a signature on the public key 601. The verifying party of the digital data D, client 205, either does not know or trust the fourth client 701 or has no access to the signature 710 of the public key 601. Instead, the second party 204 has issued a signature on that signed public key 710. This signature 711 is then obtained by the client 205 and verified using the known and trusted public key 602. If this verification 712 was successful, the client 205 establishes a trust value for both, the public key 601 and 702. Client 205 may then verify the signed digital data D using the trusted public key 601. Another embodiment is shown by the example given in FIG. 8, which corresponds to the example of FIG. 7 with the following differences. The second client 204 issues a signature 810 on the public key 702 of the fourth client 701. Client 205 can therefore in step 811 verify this signature 810 and thereby establish a trust on the public key 702. With this newly trusted public key 702, the client 205 can now obtain and verify the signature 710 and if this verification is successful, client 205 further establishes a trust on the public key 601 used to sign the digital data D.

From the above examples given in FIGS. 6 to 8, the described embodiments of the present invention may also be combined with each other and with the embodiments described in regard with the remaining figures. It should in particular be noted that a public key or a signature may be signed by more than one party and thus the chain of trust information assigned to the public key is extended to a tree of trust values, whereby several known public keys or known signing parties can be traced back for a signature on an initially un-trusted public key. In addition, some application running on a client device or a party using this method requires a certain given level of trust that may be based on the number of steps leading to a known public key in this described chain or tree of trusted identities. In the example shown in FIG. 7, the verifying party 205 has established that one unknown party 702 leads to the known party 204. Therefore, this chain has two steps whereby only one unknown party was involved. There might be some rule to accept only a public key as trusted if there is a maximum number of unknown identities leading to the eventually known and trusted identity 204. If more than one chain exists leading to a known and trusted signing party, these independently established trust level values may be combined to a single final trust value and the decision whether or not to accept a public key as trusted may be based on this final trust value. In another embodiment however the client 205 or a respective application running on a client device under the control of client 205 may require only one trust level value in order to accept a public key as trusted.

The public keys including the signatures thereon might be stored on some public servers and may also be distributed between the clients as described above in connection with the remaining embodiments and aspects of the present invention.

According to a further embodiments of the present invention, integrity information of locally used data is published by, for instance a client 203 to ensure and provide a global consistency of that data throughout the system. Often users within a system share at least parts of a global data set and there is a need to ensure that each user that uses this data can assure the integrity of that data and/or the existence of that data. In common systems, such digital data has to be signed by a trusted key of some centralized third party and all clients have to know and trust this centralized party, for instance a certificate authority. This however is not desired by most users since it may not be desirable to require a third party that can be trusted by all participating parties.

It is therefore an aspect of the present invention that a user can create a list or set of identifications for the data or parts of the data he wishes to share with other parties. The identifications uniquely identify the digital data or parts thereof and associate same with the list or set of digital data. This has been described above in connection with FIGS. 1 to 6. In the same manner as described in connection with the first aspects of the present invention, a hash value computed over the data or parts thereof is attached to each list or set of identifications. The list of identifications of data may be the sets of digital data as described in connection with the FIGS. 1 to 6. This list can be distributed by a client to another client within the system. According to one embodiment, this list of identifications including the attached hash value over some or all of its entries can be sent together with messages sent by clients during regular communication messages between the clients. Another client having received this list can now compare the identifications comprised in that list with the identifications comprised in its own list, and thereby determine whether the same data is used by the first client. If both lists comprise the same identifications, the client can determined whether the hash values match and thereby prove that both clients agree on the same data. In case there is no match, a user can be alerted respectively.

According to a further embodiment, when sending its list to some third party, a client can include another list it has received and forward the same to the third party. This allows that even seldomly used data will sooner or later find a match on some other client which is more or less steps away in this chain of distributed lists. This embodiment may be combined with the embodiments described in connection with FIGS. 6 to 8 establishing a trust level to each list or respectively the hash value thereof, whereby either additionally a signature is issued for this list or hash value. Alternatively, the hash value over the list entries may serve as the signature that is verified by recomputing and comparing the hash value over the list entries.

In particular, this procedure can be used with public keys using the client's name or identification as the above-mentioned identifications and the public key as the hashed data. Therefore, the global consistency of all public keys can be assured to the clients. Even a client receiving information about its own public key, for instance from another client, can prove that its own name or identification is signed correctly to its own public key. If public keys for each client are available, the distributed and exchanged lists or sets of identifications can be signed with these public keys. As mentioned above, some applications or clients can in addition assign trust levels depending on the sender of a received list or on how often this list was forwarded by other clients before it was received. As mentioned above, the same considerations as in connection with FIGS. 6 to 8 can be applied and this procedure may even be part of the methods described in connection with FIGS. 6 to 8.

If there is much interaction between the clients and a huge set of data is used, a client might choose to only create a list over some random or some chosen data or parts of the data it is using. According to a still further embodiment, if given data or parts thereof as specified by the identifications in a list may be changed, possibly after a certain time period, some sort of validity or time specification can further be attached or associated with a list or the respective hash value. This may be a creation time of the digital data or a timestamp information. According to yet another embodiment of the present invention, these lists or sets of data identifications may as well be distributed and transferred to a trusted third party, for instance a server or certification authority as shown in FIG. 2, and this third party may then inform a client if entries in a list do not match the entries of a corresponding list as received from another client. Similarly, another client may act in the same manner without being a trusted third party, whereby some sort of trust level as discussed above may be established. If more than one of such third parties or clients exists, each may send the information to all remaining parties or all parties may interact with each other and thereby synchronize all lists to a globally accepted list.

According to a further embodiment of the present invention, a client can assign itself to some group of clients using its own identification within the system. Before a client creates its own list, this client may request a list from at least one other client in this group of clients. The client may then add its own data to the list, or respectively the identification thereof, and may publish it to the other clients in the system or in the group. By doing this, all clients in a group can establish up-to-date information about all data entries agreed on and held by its group. This embodiment thereby provides for each client to determine the existence or non-existence of a given digital data as described above in connection with FIGS. 1 to 5. If the digital data or the identification thereof is directly related to the chosen group of clients, as for instance it can with the case of public keys, even the existence of data, for instance of a public key, in the global system 200 can be established and proven. Some other clients not in that group may therefore request the list of a group and can determine whether or not a given data exists in the global system. If in such a system third parties or special clients exist that aggregate the digital data, they may limit their action exclusively to hold and synchronize the list of that group of clients to which they are members.

Any combinations of the above described aspects and embodiments of the present invention are considered further embodiments within the scope of the present invention. Further details of the above described aspects and embodiments are described by the following claims, which form an explicit part of the disclosure of the present invention.

1. A method for managing digital data, comprising the steps of:
associating digital data with a first predefined set of digital data, whereby at least two predefined sets of digital data exist and said first predefined set of digital data can be distinguished from the other predefined sets of said at least two predefined sets;
computing a first leaf hash value over some or all of the digital data and/or over identifications of some or all of the digital data that are associated with said first predefined set;
computing a second leaf hash value over some or all of the digital data and/or over identifications of some or all of the digital data that are associated with a second predefined set of said at least two predefined sets;
if more than two predefined sets exist, for each remaining set of said at least two predefined sets;
computing respectively a leaf hash value over some or all of the digital data and/or over identifications of some or all of the digital data associated with a remaining predefined set; and
computing a root hash value, whereby the underlying hash algorithm has as an input at least said leaf hash values that are respectively computed for each of said at least two predefined sets of digital data, whereby said step of computing a root hash value comprises
computing a first non-leaf hash value over at least said first and said second leaf hash value;
said method further comprising steps for determining the consistency of given digital data with said root hash value comprising:
identifying the set of digital data that is associated with given digital data;
re-obtaining said root hash value;
re-obtaining the hash values over which said root hash value was computed, comprising a step of
re-computing the leaf hash value over some or all of the digital data and/or over identifications of some or all of the digital data associated with said identified set of digital data applying the same computing scheme as in said steps of computing a first and a second leaf hash value;
computing a hash value over said re-obtained hash values applying the same computing scheme as in said step of computing a root hash value;
comparing said re-obtained root hash values with said in the previous step computed hash value; and
determining the consistency of said given digital data with said root hash value based upon said comparing step, whereby consistency is determined if said comparing step results in equal hash values.

2. The method according to claim 1, wherein at least one of the following identifications is assigned to or obtained from each of said digital data:
a number associated with the digital data;
a unique identification of the digital data;
a predefined part of a unique identification of the digital data;
a predetermined number of bits extracted from predetermined bit positions of a digital identification associated with the digital data;
a predefined search string associated with or comprised in the digital data;
a time stamp of the digital data;
a hash value of the whole digital data;
an identifier especially created for this purpose and added to said digital data; and
a hash value of at least one of the above identifications.

3. The method according to claim 2, wherein said step of associating digital data to a first predefined set of digital data is accomplished using said at least one identification.

4. The method according to claim 2, wherein
said at least two predefined sets are identified and/or distinguished by said identifications; and wherein
said step of identifying the set of digital data that is associated with given digital data comprises
determining the at least one identification of said given digital data, whereby said identifying is accomplished using said at least one determined identification.

5. The method according to claim 2, said step of computing a first leaf hash value, said step of computing a second leaf hash value and/or said step of computing respectively a leaf hash value for each remaining predefined set if more than two predefined sets exist comprising:
obtaining the at least one identification for some or all of the digital data associated with said predefined set; and
computing a hash value over said in the previous step obtained identifications; and wherein
said step of re-computing the leaf hash value for said identified set of digital data comprises:
re-obtaining the at least one identification for some or all of the digital data associated with said identified set; and
computing a hash value over said re-obtained identifications.

6. The method according to claim 2, said step of computing a first leaf hash value, said step of computing a second leaf hash value and/or said step of computing respectively a leaf hash value for each remaining predefined set if more than two predefined sets exist comprising:
for some or each digital data associated with said predefined set computing respectively a hash value of the at least one identification; and
computing a hash value over at least said in the previous step computed hash values;
wherein said step of re-computing the leaf hash value for said identified set of digital data comprises:
obtaining the at least one identification for some or each of the digital data associated with said identified set;
computing respectively for each in the previous step obtained identification a hash value; and
computing a hash value over at least said in the previous step computed hash values.

7. The method according to claim 1, further comprising:
for each of said at least two sets of digital data computing respectively a hash value, comprising computing of each of the digital data associated with said set respectively a hash value;
wherein said step of computing a first leaf hash value, said step of computing a second leaf hash value and/or said step of computing respectively a leaf hash value for each remaining predefined set if more than two predefined sets exist comprises:
computing a hash value over at least said in the previous step computed hash values of the respective set of digital data; and
said step of re-computing the leaf hash value for said identified set of digital data comprising:
re-computing respectively a hash value of each of the digital data associated with said identified set; and
computing a hash value of said respectively re-computed hash values.

8. The method according to claim 7, wherein said step of computing respectively a hash value for each of said at least two sets of digital data is comprised in said steps of computing a first leaf hash value and/or said step of computing a leaf second hash value and/or said step of computing respectively a leaf hash value for each remaining predefined set if more than two predefined sets exist.

9. The method according to claim 1, wherein at least four predefined sets of digital data exist that can be distinguished from one another, and further comprising:
computing a third leaf hash value over some or all of the digital data and/or over identifications of some or all of the digital data associated with a third predefined set of said at least four predefined sets;
computing a fourth leaf hash value over some or all of the digital data and/or over identifications of some or all of the digital data associated with a fourth predefined set of said at least four predefined sets; and wherein
said step of computing a root hash value further comprises:
computing a second non-leaf hash value over at least said third and said fourth computed leaf hash value; and
computing a third non-leaf hash value over at least said first and said second computed non-leaf hash value.

10. The method according to claim 9, wherein said computed leaf hash values, non-leaf hash values and root hash value represent a tree structure, and wherein:
said first, said second, said third and said fourth leaf hash value are associated with a bottom layer of said tree structure;
said first and said second non-leaf hash value are associated with a second layer of said tree structure;
said third non-leaf hash value is associated with a third layer of said tree structure; and
said root hash value is associated with a top layer of said tree structure;
wherein said top layer is the highest layer of said tree structure comprising only a single non-leaf hash value, which is said root hash value.

11. The method according to claim 10, wherein further predefined sets of digital data exist, each associated with a further leaf hash values computed in the same manner as said first to fourth leaf hash value, and/or
further layers of said tree structure exist, each layer being associated with further non-leaf hash values computed over some or all of the non-leaf hash values of a respectively lower layer in said tree structure.

12. The method according to claim 10, said step of re-obtaining the hash values over which said root hash value was computed further comprising:
re-computing each non-leaf hash value in the second layer of said tree structure that was computed over hash values comprising the re-computed leaf hash value of said identified set of digital data; and
for each of the third to the top layer of said tree structure, re-computing each non-leaf hash value that was computed over hash values comprising a non-leaf hash value that was re-computed in this step or said previous step.

13. The method according to claim 12, said step of re-obtaining the hash values over which said root hash value was computed further comprising:
providing all remaining leaf hash value required in said step of re-computing each non-leaf hash value in the second layer of said tree structure that was computed over hash values comprising the re-computed leaf hash value of said identified set of digital data; and
providing all remaining non-leaf hash value required in said step of re-computing each non-leaf hash value for each of the third to the top layer of said tree structure.

14. The method according to claim 10, said step of computing the root hash value further comprising:
dividing said predefined sets into a plurality of groups of predefined sets;
computing for each of said groups of predefined sets a non-leaf hash value over the computed leaf hash values of the predefined sets in said group; and
for each of the third to the top layer of said tree structure dividing the non-leaf hash values of the next lower layer into at least two groups and computing a non-leaf hash value over the non-leaf hash values of each group.

15. The method according to claim 14, wherein for each layer L of said tree structure said predefined sets and/or said non-leaf hash values of the next lower layer L−1 are divided into groups of a predefined number B_{L} of predefined sets or non-leaf hash values.

16. The method according to claim 15, further comprising:
determining whether the total number of predefined sets is an integer multiple of said predefined number Bₗ;
if said total number is not an integer multiple of Bₗ creating at least one group comprising respectively less than Bₗ predefined sets, or creating at least two groups both comprising at least one identical predefined set;
determining for each of said second to said top layer of said tree structure L whether the total number of non-leaf hash values of the next lower layer L−1 is an integer multiple of said predefined number B_{L}; and
if said total number is not an integer multiple of B_{L} performing one of the following:
creating at least one group comprising respectively less than B_{L} non-leaf hash values of the next lower layer L−1;
creating at least two groups both comprising at least one identical non-leaf hash values of the next lower layer L−1; or
creating at least one group comprising at least one hash value of a lower layer L−N, wherein N>1 and L>2.

17. The method according to claim 1, wherein each digital data is associated with one of said plurality of predefined sets.

18. The method according to claims 17, wherein different sorts of digital data are associated with different predefined sets.

19. The method according to claim 1, wherein digital data can be associated with more than one of said predefined sets of digital data.

20. The method according to claim 19, wherein if said given digital data is associated with more than one predefined sets of digital data, said step of determining the consistency of said given digital data with said root hash value comprises:
identifying respectively more than one predefined sets; and
re-computing a leaf hash for each of said more than one identified sets.

21. The method according to claim 1, wherein said non-leaf hash values are computed over exclusive groups of leaf hash values and/or non-leaf hash values.

22. The method according to claim 1, wherein the total number of predefined sets is S, whereby S is an integer power E of an integer B.

23. The method according to claim 22, wherein for each of said S predefined sets a leaf hash value is computed, and
said step of computing the root hash value comprises:
(a) dividing said S predefined sets into E+1 mutually exclusive groups of B predefined sets;
(b) for each of said E+1 groups computing a non-leaf hash value over the computed leaf hash values of the B predefined sets of said group;
(c) dividing said in the previous step computed non-leaf hash values into exclusive groups of B non-leaf hash values;
(d) computing for each of said exclusive groups in the previous step a non-leaf hash value over the B non-leaf hash values of said group; and
(e) repeating steps (c) and (d) until a single non-leaf hash value is computed, which is said root hash value.

24. The method according to claim 22, wherein said integer B is an integer power of 2.

25. The method according to claim 1, wherein said given digital data is distributed to a client in a server-client system comprising at least one server and a plurality of clients,
said steps of computing the leaf hash values for each predefined set of digital data, the steps of computing the non-leaf hash values and said step of computing the root hash value are performed by said server;
said steps for determining the consistency of said given digital data with said root hash value are performed by said client;
said method further comprising:
distributing said root hash to a plurality of clients of said server-client system.

26. The method according to claim 25, wherein said step of distributing said root hash to a plurality of clients is performed by said server.

27. The method according to claim 25, wherein said root hash value is distributed among said plurality of clients by sending said root hash value by a first client to a second client, whereby said first client had previously received said root hash value from said server and/or from one or more of said plurality of clients.

28. The method according to claim 25, wherein said distributed root hash value is associated with time-stamp or validity information.

29. The method according to claim 28, wherein said root hash value is replaced, updated and/or requested from said server by a client based on said time-stamp or validity information.

30. A computer-readable medium comprising instructions for controlling a client device in a server-client system, said instructions causing said client device to perform the steps of:
receiving a root hash value, said root has value being computed according to the method in any one of claims 1 to 29;
determining the consistency of given digital data with said root hash value comprising:
identifying a set of digital data that is associated with given digital data;
obtaining the hash values over which said root hash value was computed, comprising:
requesting some or all of the digital data and/or identifications of some or all of the digital data associated with said identified set of digital data from a server of said client-server system;
computing a leaf hash value over said requested some or all of the digital data and/or identifications of some or all of the digital data associated with said identified set of digital data;
determining the remaining leaf and non-leaf hash values that are required to compute said root hash value; and
requesting said remaining leaf and non-leaf hash values from said server;
computing a hash value over said obtained hash values applying the same computing scheme as in said step of computing a root hash value;
comparing said received root hash values with said in the previous step computed hash value; and
determining the consistency of said given digital data with said received root hash value based upon said comparing step, whereby consistency is determined if said comparing step results in equal hash values.

31. A computer-readable medium comprising instructions for controlling a server in a server-client system, said instructions causing said server to perform the following steps according to the method in any one of claims 1 to 29:
associating digital data with a first predefined set of digital data, whereby at least two predefined sets of digital data exist and said first predefined set of digital data can be distinguished from the other predefined sets of said at least two predefined sets;
computing a first leaf hash value over some or all of the digital data and/or over identifications of some or all of the digital data that are associated with said first predefined set;
computing a second leaf hash value over some or all of the digital data and/or over identifications of some or all of the digital data that are associated with a second predefined set of said at least two predefined sets;
if more than two predefined sets exist, for each remaining set of said at least two predefined sets:
computing respectively a leaf hash value over some or all of the digital data and/or over identifications of some or all of the digital data associated with a remaining predefined set;
computing a root hash value, whereby the underlying hash algorithm has as an input at least said leaf hash values that are respectively computed for each of said at least two predefined sets of digital data, whereby said step of computing a root hash value comprises a step of:
computing a first non-leaf hash value over at least said first and said second leaf hash value; and
distributing said root hash value to a plurality of clients of said client-server system.

32. A method for providing trust levels of signatures in a system comprising a plurality of parties connected via a public network, said system providing a public key signature scheme for said pluralities of parties, said method comprising:
signing a public key PK1 of a first party by a second party using a private key SK2;
signing digital data D by said first party using the private key SK1 corresponding to said signed public key PK1;
obtaining said signed digital data D and said signed public key PK1 by a third party, whereby said first party is unknown and/or not trustworthy to said third party;
determining said second party as a signing party of said signed public key PK1;
determining whether said second party as a signing party is known and/or trusted by said third party; and
if said second party as said signing party is known and/or trusted by said third party, performing the steps of:
(a) obtaining the public key PK2 of said second party corresponding to said private key SK2;
(b) verifying said signed public key PK1 using said public key PK2 of said known and/or trusted signing party; and
(c) if the verification of said signed public key PK1 was successful, verifying the signed digital data D using said signed public key PK1.

33. The method according to claim 32, wherein a public key is accepted for verifying a signature on digital data and/or on another public key by a verifying party only if the corresponding signing party in possession of the corresponding private key to said public key is known and/or trusted by said verifying party.

34. The method according to claim 32, further comprising if said second party as said signing party is known and/or trusted by said third party and if the verification of said signed public key PK1 was successful,
said third party registering said first party and/or said public key PK1 as trusted for further succeeding signatures issued by said first party using said private key SK1.

35. The method according to claim 32, wherein said digital data D comprises a public key of a further party of said system.

36. The method according to claim 32, further comprising:
if said second signing party is not known and/or not trusted by said third party, performing the steps of:
(i) determining whether a further signing party has issued a signature of said signed public key PK1;
(ii) if a further signing party signature of said signed public key PK1 is determined and said further signing party is known and/or trusted by said third party, performing the steps (a), (b) and (c) with the public key of said further signing party; and
(iii) if no further signing party of said signed public key PK1 is determined, and/or no trusted further signing party is determined, performing steps of:
1. obtaining the public key PK2 of said second party corresponding to said private key SK2;
2. determining whether a fourth signing party has issued a signature of said second public key PK2; and
3. if a fourth signing party has issued a signature on said second public key PK2, determining whether said fourth signing party is known and/or trusted by said third party, and if said fourth signing party is known and/or trusted by said third party, performing the steps (a), (b) and (c) with the public key PK4 of said fourth signing party.

37. The method according to claim 36, wherein the public key PK4 of said fourth signing party is signed by a fifth signing party, said method further comprising:
4. if said fourth signing party is not known and/or not trusted by said third party, performing the steps (i) and (ii) applied to said public key PK2, and performing the step (iii) respectively applied to the public key PK4, the fifth party, and the public key PK5.

38. The method according to claim 32, wherein a public key is accepted for verifying a signature on digital data and/or on another public key by a verifying party, only if the corresponding signing party in possession of the corresponding private key to said public key is known and/or trusted by said verifying party, and wherein
an unknown public key is trusted, if said public key is signed and the signature can be verified with another trusted and/or known public key.

39. The method according to claim 38, further comprising:
establishing a trust level of a public key, whereby said trust level is based on the number of unknown public keys in the chain of public keys to a known public key that are required to accept said public key for verifying a signature.

40. The method according to claim 38, wherein one or more public keys in said system and/or signatures corresponding to said public keys are identified to a verifying party as not trusted, and wherein said one or more public keys and/or said signatures are not used in said chain of public keys to establish whether a unknown public key is trusted.

41. The method according to claim 39, wherein a trust information is assigned to a signature of a public key or to the public key used to verify said signature, and said trust information assigned to one or more public keys in said chain of public keys is used to establish said trust level.

42. The method according to claim 38, wherein more than one chain of public keys are used to establishing a trust level of a public key, whereby the trust levels of all chains are combined to a single trust level, or the highest trust level is used.

43. The method according to claim 32, wherein said public keys and/or the signatures of said public keys are stored on a server of said system, whereby said server is connected to said parties via said public network and said public keys and/or said signatures of said public keys are distributed to a party of said system by said server and/or by another party of said system.

44. The method according to claim 42, wherein said server aggregates all signatures that are associated with said more than one chains to establishing a trust level, and said server assigns the aggregated or combined trust level to a further signature that is issued by said server.

45. A method for providing integrity and consistency information of digital data for at least two parties of a system comprising a plurality of parties connected via a public network, said method comprising:
creating a list of identifications of digital data by a first party of said system;
computing a hash value over some or all of the identifications of said list;
associating said hash value with said list;
providing said list and said hash value to a second party of said system;
comparing one or more of identifications in corresponding list in possession of said second party with the corresponding one or more of identifications in said obtained list; and
verifying the consistency of both lists comprising the steps of:
computing a hash value over some or all of the identifications of said obtained list;
computing or obtaining a hash value over some or all of the identifications of said corresponding list;
comparing both hash values; and
if said comparing step results in equal hash value, establishing that both list are consistent.

46. The method according to claim 45, wherein said step of associating said hash value with said list comprises attaching said hash value to said list.

47. The method according to claim 45, wherein said step of verifying the consistency of both lists further comprises a step of:
if said comparing step results in different hash value, informing said first and/or said second party.

48. The method according to claim 45, wherein said step of verifying the consistency of both lists further comprises a step of:
if said comparing step results in different hash value, creating an alert accessible by other parties of said system.

49. The method according to claim 45, wherein said digital data are public key of parties in said system.

50. The method according to claim 45, wherein said list and/or identifications in said list are digitally signed by said first party.

51. The method according to claim 45, wherein said identification of digital data is said digital data.

52. The method according to claim 45, wherein a group of clients maintains mutually consistent list by interchanging said list and any update of said list between all clients of said group, whereby said list comprises a set of digital data and/or identifies of digital data.

53. The method according to claim 52, wherein at least one of the following identifications is assigned to or obtained from each of said digital data:
a number associated with the digital data;
a unique identification of the digital data;
a predefined part of a unique identification of the digital data;
a predetermined number of bits extracted from predetermined bit positions of a digital identification associated with the digital data;
a predefined search string associated with or comprised in the digital data;
a time stamp of the digital data;
a hash value of the whole digital data;
an identifier especially created for this purpose and added to said digital data; and
a hash value of at least one of the above identifications.

54. The method according to claim 53, wherein said set of digital data is determined by said identifications by associating digital data to said set using said at least one identification for each digital data, or said set of digital data is determined by a client identification.

55. The method according to claim 53, wherein said at least two predefined sets are identified and/or distinguished by said identifications; and said method further comprising:
identifying the set of digital data that is associated with given digital data comprising determining the at least one identification of said given digital data, and whereby said identifying is accomplished using said at least one determined identification.

56. The method according to claim 53, wherein a predetermined group of clients maintains a mutually consistent predetermined list of digital data.

57. The method according to claim 56, wherein said predetermined list of digital data is maintained and interchanged in a server-client system comprising at least one server and a plurality of clients, said steps of computing the leaf hash values for each predefined set of digital data, the steps of computing the non-leaf hash values and said step of computing the root hash value are performed by said server:
said steps for determining the consistency of said given digital data with said root hash value are performed by said client; said method further comprising:
distributing said root hash to a plurality of clients of said server-client system.

58. The method according to claim 57, wherein said clients in said group and/or further parties in said system interchange leaf hash values with one or more other group of clients and thereby compute non-leaf hash values and said root hash value.

59. The method according to claim 58, wherein one or more clients of each group of clients accomplish the functionality of distributing the root hash value.

60. The method according to claim 58, wherein said server is a client in each group of clients.

61. A computer-readable medium comprising instructions for controlling a client device in a client-server system, said instructions causing said client device to participate in a method according to any one of claims 32 to 60.

62. A computer-readable medium comprising instructions for controlling a server in a client-server system, said instructions causing said server to participate in a method according to any one of claims 32 to 60.
